(19) United States
(12) Patent Application Publication
(10) Pub. No.: US 2008/0270183 A1
(43) Pub. Date: Oct. 30, 2008

(54) SYSTEMS AND METHODS FOR PRESENTATION OF CLINICAL EVIDENCE FOR DIAGNOSTIC INTERPRETATION

(76) Inventors: Michael Hawkins, Hoboken, NJ (US); Dmitry Pavlov, New Paltz, NY (US); Alex Jurovitsky, Mahwah, NJ (US); Andrei Leontiev, South Burlington, VT (US); Alexander Natanzon, Mahwah, NJ (US); Christopher Burt, Warwick, NY (US)

Correspondence Address: MCANDREWS HELD & MALLOY, LTD, 500 WEST MADISON STREET, SUITE 3400, CHICAGO, IL, 60661, US

(21) Appl. No.: 12/110,053

(22) Filed: Apr. 25, 2008

Related U.S. Application Data
(60) Provisional application No. 60/926,356, filed on Apr. 26, 2007.

(51) Int. Cl. G06Q 50/00; G06Q 10/00; G06F 17/30

(52) U.S. Cl. 705/2

(57) ABSTRACT

Certain embodiments of the present invention provide systems and methods for presentation of clinical evidence to a user. Certain embodiments provide an improved picture archiving and communication system (PACS) including a workflow manager facilitating presentation and diagnostic interpretation of clinical evidence aggregated from a plurality of sources. The PACS also includes a workflow screen including a plurality of presentation panes. Each of the plurality of presentation panes displays clinical evidence from the workflow manager according to a particular perspective. The plurality of presentation panes are independent but coordinated, and each of the plurality of presentation panes is context sensitive.

### RELATED APPLICATIONS

The present application claims the benefit of priority to U.S. Provisional Application No. 60/926,356, filed on Apr. 26, 2007, entitled “Special Methodics for Optimal Presentation of the Clinical Evidences for Diagnostic Interpretation”, which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF INVENTION

The present invention relates to the field of reading and interpretation of medical exams including diagnostic imaging exams, stored in their digital representation and searched, retrieved and read using computer-based information systems, some of them commonly referred as PACS (Picture Archiving and Communication Systems). A specific of such a reading presumes that said images are stored on centralized server while reading is performed from remote workstations connected to the server via electronic information links. Same information links often connect the reading workstation with other information systems providing variety of clinical information (further referred as clinical evidence) additional to and, possibly, of different nature than clinical information provided by diagnostic medical images stored in PACS, or even directly associated to said imaging examination.

### BACKGROUND OF THE INVENTION

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

It is now a common practice that medical imaging devices produce diagnostic images in a digital representation. The digital representation typically includes a two dimensional raster of the image equipped with a header. The header includes collateral information with respect to the image itself, patient demographics, imaging technology and other data important for proper presentation and diagnostic interpretation of the image. Often, diagnostic images are grouped in series. Each series represents images that have something in common while differing in details—for example, images representing anatomical cross-sections of a human body substantially normal to its vertical axis and differing by their position on that axis from top to bottom are grouped in an axial series. A single medical exam, often referred to as a “Study” or “Exam”, often includes several series of images—for example, images exposed before and after injection of contrast material or by images with different orientation or differing by any other relevant circumstance(s) of imaging procedure.

Digital images are forwarded to specialized archives equipped with proper hardware and/or software for safe storage, search, access and distribution of the images and collateral information required for successful diagnostic interpretation. An information system controlling the storage is aware of multiple current and historical medical exams carried over for the same patient, diagnostic reports rendered on the basis of the exams, and, through its interconnectivity to other information systems, can posses the knowledge of other existing clinical evidences stored on, or acquired from, the other information systems. Such evidence can be further referred as “collateral clinical evidences.”

Additionally, in diagnostic reading, rendering a diagnostic report is based not only on the newly acquired diagnostic images but also involves analysis of other current and prior clinical information, including but not limited to prior medical imaging exams. In recent history, a reading physician was naturally limited to few sources of such clinical data including probably a film jacket of one to three prior studies and other clinical evidence printed on an exam requisition form.

However, with an information revolution extending into healthcare enterprises, practically all clinical evidence is subject to storage and presentation through various information systems—sometimes accessed in separate systems, but more and more integrated for cross-system search and retrieval. Such principal availability of extensive clinical history presents a serious challenge to ergonomic design of diagnostic workstations that allow easy and effective search and navigation within a multiplicity of clinical evidence to facilitate productivity of diagnostic reading without risk of missing an important piece of clinical evidence which loss or neglecting can substantially change diagnostic conclusion or affect important details of a diagnostic report.

### BRIEF SUMMARY OF THE INVENTION

Certain embodiments of the present invention provide systems and methods for presentation of clinical evidence to a user.

Certain embodiments provide an improved picture archiving and communication system (PACS) including a workflow manager facilitating presentation and diagnostic interpretation of clinical evidence aggregated from a plurality of sources. The PACS also includes a workflow screen including a plurality of presentation panes. Each of the plurality of presentation panes displays clinical evidence from the workflow manager according to a particular perspective. The plurality of presentation panes are independent but coordinated, and each of the plurality of presentation panes is context sensitive.

Certain embodiments provide a method for presentation of clinical evidence. The method includes aggregating clinical evidence from a plurality of information sources. The method also includes generating a workflow management screen from a plurality of presentation panes. Each of the plurality of presentation panes displays at least a portion of the clinical evidence according to a particular perspective. The plurality of presentation panes are independent but coordinated, and each of the plurality of presentation panes is context sensitive. The method further includes providing the clinical evidence for review via the plurality of presentation panes.

Certain embodiments provide a computer readable medium having a set of instructions for execution on a computing device and a processor for executing the set of instructions on the computer readable medium. The set of instructions includes a workflow management routine aggregating clinical evidence from a plurality of information sources. The set of instructions also includes a workflow screen routine generating a plurality of presentation panes. Each of the plurality of presentation panes displays at least a portion of the clinical evidence according to a particular perspective. The plurality of presentation panes are independent but coordinated, and each of the plurality of presentation panes is context sensitive.

### BRIEF DESCRIPTION OF SEVERAL VIEWS OF THE DRAWINGS

FIG. 1 illustrates a graphical workflow manager including a plurality of presentation panes in accordance with an embodiment of the present invention.

FIG. 2 demonstrates a business and application diagram for PACS information system in accordance with an embodiment of the present invention.

FIG. 3 illustrates an architecture of front-end components, thin and thick clients, and applications running partially on client workstations in accordance with an embodiment of the present invention.

FIG. 4 shows a flow diagram for a method for presentation of clinical evidence in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention relates to the field of reading and interpretation of medical exams including diagnostic imaging exams, stored in their digital representation and searched, retrieved and read using computer-based information systems, such as PACS (Picture Archiving and Communication Systems). A specific of such a reading presumes that the images are stored on a centralized server while reading is performed from remote workstations connected to the server via electronic information links. The same information links often connect the reading workstation with other information systems providing variety of clinical information (further referred to as clinical evidence) in addition to and, possibly, of different nature than clinical information provided by diagnostic medical images stored in a PACS, or even directly associated with the imaging examination.

Certain embodiments are targeted toward more optimal or improved presentation of a multiplicity of clinical evidence (both current and historical) to a physician in its most complete and perceived way that enables an improved or more optimal data mining for relevant clinical evidence, and/or reduces a risk of missing pieces of evidence for interpretation of diagnostic images.

It should be clear for any one skilled in the art that being a primary field of invention, diagnostic imaging interpretation is not the only relevant field of applicability. Certain embodiments can be successfully applied to any local or distributed information system dedicated to providing media content and collateral information to a single and/or multiplicity of workstations, whereas there are or can be additional and/or multidisciplinary and/or historical media content(s) or any other collateral evidence(s) of various types and nature, whereas the timely discovery and multi-tiered analysis of the collateral evidence(s) can be or is important and/or critical for perception and/or presentation and/or interpretation of the basic media and/or information content stored in an information system and distributed through the system for examination and/or analysis and/or decision making and/or for any other purpose workflow.

Certain embodiments provide methods and systems for more optimum presentation, search, discovery, drill down, retrieval, and/or examination of collateral clinical evidence of various types, nature, and/or time period, which evidence is available in the PACS environment either in its intrinsic storage subsystems or through links to external information clinical systems including but not limited to Radiology Information Systems (RIS), Electronic Medical Records (EMR), Laboratory Information Systems, (RIS) Hospital Information Systems (HIS), Insurance Provider's Information Systems, and/or other archives and information systems, for example.

According to certain embodiments of the invention, a workstation screen can be dedicated to support multiple graphical and textual forms of presenting available main and collateral clinical evidence that can be easily searched, discovered, drilled down and retrieved for full blown presentation and analysis either on the same screen or on another screen of the workstation, for example. The specialized screen will be further referred as a “Workflow Screen”. The Workflow Screen can include a plurality of “Presentation Panes”—each pane representing a specialized view over the available clinical evidence in various perspectives including but not limited to: historical, anatomical, demographical, administrative, subspecialty, other perspective, and/or through a specialized mix of selected basic perspectives, for example.

According to any of disclosed embodiments of the invention, the combination of presentation panes can be pre-configured and/or personalized on multiple levels of an enterprise, administrative and/or subspecialty groups, or individual level, for example. The combination of presentation panes and/or behavior of each individual pane can be set to be context sensitive respective to a wide variety of factors including but not limited to patient personalized data, a nature of a medical case, and a current workflow as a whole, for example. One or more panes can adjust to a current step within an overall workflow, for example.

Content of the presentation panes can be synchronized between any two or more panes as part of a customization pattern, and/or by explicit choice of an operator, for example. For purposes of example only, selection of an anatomical region (e.g., an abdominal region) on anatomical presentation pane automatically reduces a list of historical exams to only those prior exams targeted to the selected anatomical part. As another example, a selection of “oncology” from an exam types list will focus primarily on clinical evidence gathered with respect to oncology while leaving other information in close proximity, but probably with less visible details and/or involving a series of actions (e.g., multiple mouse clicks) to be reached/drilled down.

All disclosed embodiments of the present invention can optionally feature the following properties: 1. Each presentation pane can have its different context sensitive graphical user interface (“GUI”) controls including but not limited to mouse operational modes, toolbars, right-click menus, others and/or a combination of the above, for example. 2. Graphical and/or overlay elements of each of presentation panes can be clickable and/or otherwise selectable resulting in a certain action happening upon clicking or selecting an element, thus being a special sort of interactive controls, for example.

It should be clear for any person skilled in the art that certain embodiments of the present invention should not be limited only to the multiplicity of disclosed embodiments. Alternatively these embodiments and/or nature of the information system should be considered as a convenient way of presenting basic principles, novelty concepts and inventive steps of certain embodiments of the present invention for the purpose of an application for patent.

Certain embodiments of the present invention are described in conjunction with graphical representation in the drawings. The invention itself should not be limited to the illustrative embodiments only. On the contrary, those embodiments should be regarded as particular examples of interactive systems and methods for effective search, discovery, data mining, drill down, retrieval and/or display for detailed examination of a piece or group of multidisciplinary collateral evidence for interpretation of examined media to help increase human productivity and interpretation quality, and/or help reduce a risk that an important piece of collateral evidence is missed.

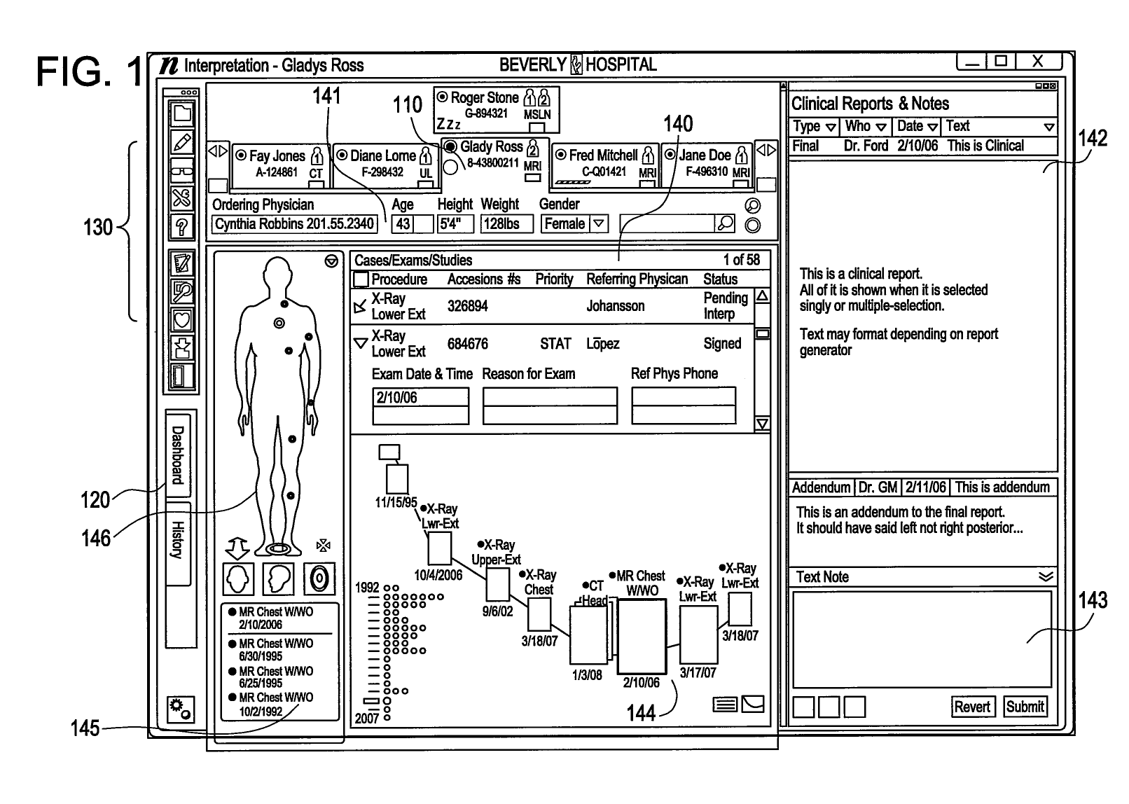

According to certain embodiments, one of a workstation's screens is used in whole or in part for display of interactive visual control called a “Workflow Manager”. The workflow manager is used for presentation, search, data mining, drilling down, selection, and/or retrieval for detailed examination (including but not limited to presentation on same or other display screens) of various collateral clinical evidences varying in aspects including but not limited to: method of acquiring, method of storing, stored internally or accessed through external connections, way of presentation and analysis, among others. One particular implementation of the control is presented in FIG. 1.

According certain embodiments, a graphical space of the workflow manager includes independent, yet coordinated, visual panes as demonstrated by FIG. 1.

According certain embodiments, one of such panes represents a queue of examination cases one of which is opened now, while others are pending interpretation according to their order in the worklist.

According certain embodiments, one of the presentation panes represents a history of medical events for a patient including but not limited to visits, tests, treatments, diagnostic imaging, among others, for example. The historical representation characterizes each historical period (e.g., a year) with respect to an intensity of medical events discriminating or dividing them into distinctly perceived groups. For illustrative purpose only, events may be divided into events with positive, neutral and negative outcome. The discrimination may be performed based on one or more criterion including but not limited to: shape, color, brightness, etc. Scrolling of the historical line or selection of a certain period can optionally result in focusing of one or several other panes onto one or a group of its native objects that are related to the same or a close historical period, for example. The focusing is governed by pre-defined or interactively activated rules, for example.

According to certain embodiments, one of the presentation panes includes a graphical representation of a human anatomy in one or multiple aspects including but not limited to: body parts, organs, diseases, medical subspecialties, etc. Focusing on one or more of these objects or on a group of them can optionally result in focusing of one or several other panes onto one or a group of its native objects related to the same or close anatomical aspects according to pre-defined or interactively activated rules, for example.

According to variation of the above embodiment, a style of anatomical presentation can vary to be context sensitive to various factors including but not limited to gender and/or age group of the patient, and/or selections made on other presentation panes, and/or other factors or combination of several such factors, for example.

According to certain embodiments, one of a multiplicity of the presentation panes includes a graphical representation of a multiplicity of clinical evidence displayed in an ordered and grouped manner.

Particular rule of said ordering and grouping can be set by rules—predefined, and/or context sensitive, provided that said rules can be modified and/or overruled by any interactive activity of the user in same or other panes. For exemplary purpose only we can consider that when any specific anatomy is selected in anatomical presentation pane the clinical evidences are grouped by years and ordered by historical periods, or alternatively—upon any activity in historical pane evidences become grouped by type of clinical evidences and ordered through their historical attribution. Focusing on either of these groups of objects or on either specific object can optionally result in focusing of one or several other panes onto one or group of their native objects, related to objects according to pre-defined, and/or context sensitive, and/or interactively activated rules.

According to certain embodiments, the above “evidence” representation objects or any other respective grouped and/or ungrouped object(s) on any other panes can be optionally organized as interactive ruler, carousel, and/or any other mechanical association that allows repositioning of the focus from one group of evidence onto another via a perceived “scrolling of associated mechanical representation,” thus keeping the object of focus always in the middle of the order for better perception of other objects or groups of objects preceding and succeeding the object in focus.

According to a variation of the above embodiment, content of each group of evidence can be context sensitive to selections and options activated in the course of a work process and/or in other panes, for example.

According to certain embodiments, the objects representing “evidence” and/or any other respective grouped and/or ungrouped object on other pane(s) can be optionally presented in such a way that a physical size of representation and a number of details included in such presentation is dependent on proximity of an object to the object in focus. Thus, improved perception of more details in object of focus and neighboring ones is facilitated, although only a broad or “30,000 feet view” of more distant objects and/or groups of objects is given.

According to certain embodiments, focusing on any object or group of objects by hovering over an object or group of objects with a mouse cursor or any other suitable action optionally causes other inactive presentation pane(s) to focus on a drilled-down level of presentation for the object in focus on active presentation pane, thus presenting relevant properties of the highlighted object and/or group of objects. Optionally, the drill down presentation can be a plain geometrical blow-up or magnification of the same group highlighted on the active pane.

According to certain embodiments, one of the panes can be used as an organizer of the objects selected via interactions on other panes. The process of selection of the objects for the organizer can be viewed as similar to selection of merchandise into “shopping carts” on commercial websites, for example. However, usage of the objects included into the organizer is different from traditional “shopping cart checkout” and depends on a variety of factors including but not limited to the nature of the objects, continuation of the workflow, and/or rule of context sensitivity, and variety other factors and/or combination of factors, for example.

According to certain embodiments, action controls including but not limited to toolbars menus, right-click menus, mouse operation mode, and/or others can be different for different panes and/or context sensitive to variety of factors including but not limited to: actual context of the pane or some of its specific objects, and/or workflow step, etc.

According to certain embodiments, each clinical evidence or group of clinical evidences is represented by its most meaningful and diagnostically important component. For purposes of example only, assume that each diagnostic imaging study is represented by one or several of its key images, while each image series is represented by its “meaningful image” which was once included into a key images set, etc.

According to certain embodiments, each presentation pane can be frozen in its content (e.g., pinned down) and its context sensitive synchronization to other panes or workflow steps can be temporarily suspended.

According to certain embodiments, highlighting of an object and/or group of objects provides temporarily drill-down screen similar to “tooltip” postings of the Microsoft Windows® operating system.

According to certain embodiments, workflow control supports collaboration activities so that actions of independent users performed on physically different and—optionally—remotely located workstations will be replicated or otherwise synchronized towards the workstation(s) of the collaboration partner(s), thus facilitating a substantially identical flow of events and presentation instances on all workstations of collaborating parties.

According to certain embodiments, workflow and collaboration can include notifications and messaging to other parties including referring physicians.

According to certain embodiments, a chain of actions undertaken within the workflow manager including but not limited to data discovery, data search, data drill-down, data retrieval and display for examination, collaboration sessions, notifications and messaging, and/or others are logged and recorded for various purposes including but not limited to: teaching, presentation to supervisor, recollection and reproduction, guided instructions, legal recording, and/or other purposes or combination of purposes, for example.

As illustrated, for example, in FIG. 1, a graphical workflow manager 100 includes one or more patient tabs 110, one or more sections 120 for each tab 110, one or more tools 130 for use with data in the tab(s) 110, and a plurality of presentation panes 140-147 with information regarding a patient, for example.

The example workflow manager 100 shown in FIG. 1 includes an examination status or queue pane 140, a patient demographic pane 141, a clinical report pane 142, a notes pane 143, a history of events pane 144, an image or exam series pane 145, and a patient anatomy pane 146. Other embodiments may include additional panes, fewer panes, and/or other combinations of panes and corresponding information/evidence, for example. As described above, a user may select a tab 110 to view clinical evidence regarding a particular patient. Within the tab, the examination status pane 140 provides the user with a view of available cases, examinations, and/or other studies and their status (e.g., pending interpretation, reviewed, signed, etc.). The demographics pane 141 provides demographic information regarding the patient, such as age, height, weight, gender, name, ordering/referring physician, etc.

The clinical report pane 142 and the note pane 143 may be implemented together or separately and provide a user with a clinical report and notes/addendum to the report and/or other observation to be entered by a user and/or other healthcare practitioner, for example. This information can then be made available for review and/or modification via the presentation pane(s) 142, 143.

Presentation pane 144 provides a history of events, such as examinations/images, for the patient. In certain embodiments, one or more events may be selected in the pane 144 to retrieve the contents of that event (e.g., examination images and/or reports) for review.

Presentation pane 145 provides series of images/exams for a patient, for example. Pane 146 provides a graphical representation of patient anatomy. The anatomy representation may include a graphical indication of findings and/or other events/conditions for the patient, areas of image data for the patient, and/or other information, for example. Such graphical indication may include a link to additional information, may trigger display of information in another pane, and/or may prompt a user to manually retrieve additional information, for example.

In certain embodiments, sections 120 of the workflow manager 100 may provide access to additional information and/or functionality, such as patient history, dashboard information, etc.

Certain embodiments of the present invention provide a variety of methods and technologies for more effective development, deployment and support of sophisticated distributed information systems more uniformly encompassing various subspecialties and professional workflows. Certain embodiments help deliver cost effective, reliable, and secure products with a low cost of ownership, high reliability, and versatility. While healthcare enterprises represent a preferred environment for certain embodiments, it should be clearly understood that healthcare enterprises cannot be considered as the only area of application. For example, certain embodiments should be considered applicable to any field of development involving vending and support of distributed high-sophisticated information with strict requirements for reliability, secure data storage/data access and including multiplicity of the workflows for multiplicity of user groups of different subspecialties.

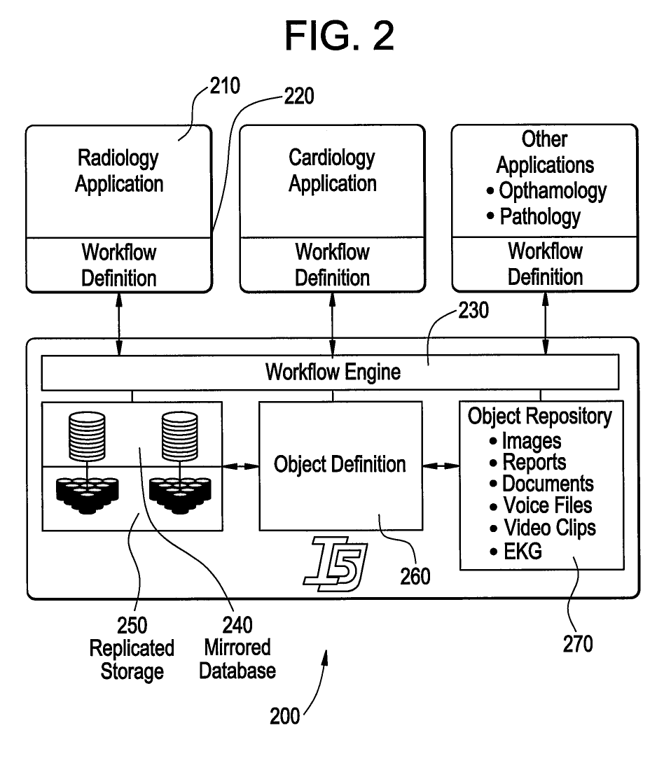

Certain embodiments may be implemented in conjunction with an information system for a healthcare enterprise including a PACS IT system for radiology and/or other subspecialty system as demonstrated by the business and application diagram in FIG. 2.

The system 200 of FIG. 2 includes a clinical application 210, such as a radiology, cardiology, ophthalmology, pathology, and/or application. The system 100 also includes a workflow definition 220 for each application 210. The workflow definitions 220 communicate with a workflow engine 230. The workflow engine 230 is in communication with a mirrored database 240, object definitions 260, and an object repository 270. The mirrored database 240 is in communication with a replicated storage 250. The object repository 270 includes data such as images, reports, documents, voice files, video clips, EKG information, etc.

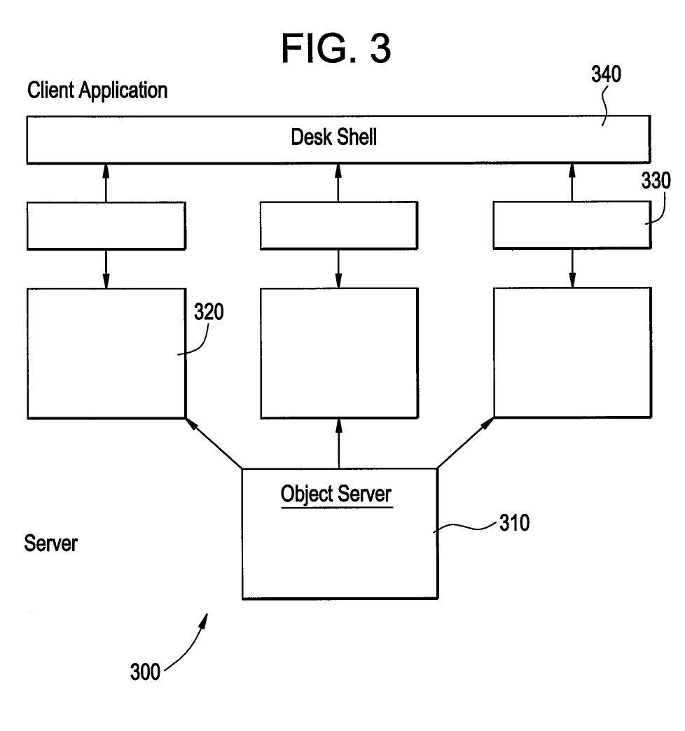

Certain embodiments may be implemented in conjunction with an architecture of front-end components including but not limited to a Graphical User Interface (GUI), thin and thick clients, applications running partially on the client workstations, and others. One embodiment of this architecture is presented in FIG. 3. The architecture 300 of FIG. 3 provides the following definite advantages for multi-specialty system development, support and evolution. For parallel development, a system can be divided into independent applications and application modules. Modules designed for one application can be reused in other applications. There is no need to split teams based on physical tiers (e.g., a client team and a server team). An object server 310 can communicate with applications 320 and application modules 330 to provide functionality to a user via a desk shell 340 running on a client workstation. Applications 320 can run partially on a client workstation and partially on a server, for example.

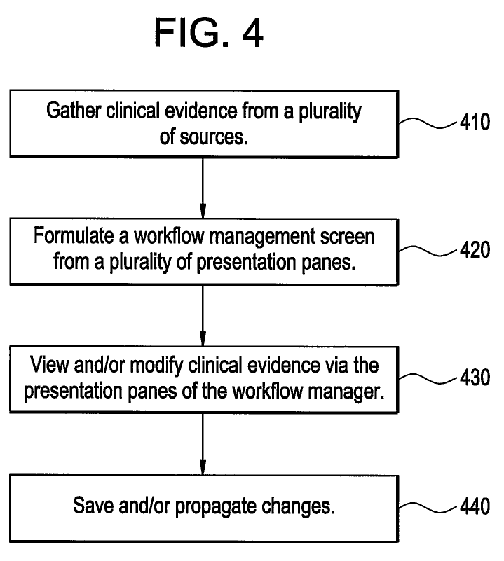

FIG. 4 depicts a flow diagram for a method for presentation of clinical evidence in accordance with an embodiment of the present invention. At step 410, clinical evidence is gathered from a plurality of sources. For example, clinical evidence from clinical information systems such as RIS, EMR, LIS, HIS, PACS, and/or other storage, may be aggregated for presentation to a user.

At step 420, a workflow management screen is formulated from a plurality of presentation panes. Each pane presents certain clinical evidence. The panes may correlate or be synchronized to provide different evidence related to a particular patient, clinical practitioner, healthcare enterprise, etc. As described above, one or more panes may be context sensitive and may provide various perspectives on the clinical data.

At step 430, clinical evidence and/or other data may be viewed and/or modified via the presentation panes of the workflow manager. For example, images, findings, and the like may be highlighted, retrieved, magnified, etc., based on information presented in the panes of the workflow manager interface. Clinical evidence and/or related findings may be modified, such as through generation of a report and/or notes regarding an image study. At step 440, any changes may be saved and/or propagated to other systems.

One or more of the steps of the method 400 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

It should be understood by any experienced in the art that the inventive elements, inventive paradigms and inventive methods are represented by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

For example, certain embodiments may be implemented as a computer readable medium having a set of instructions for execution on a computing device and a processor for executing the set of instructions on the computer readable medium. The set of instructions includes a workflow management routine aggregating clinical evidence from a plurality of information sources. The set of instructions also includes a workflow screen routine generating a plurality of presentation panes. Each of the plurality of presentation panes displays at least a portion of the clinical evidence according to a particular perspective. The plurality of presentation panes are independent but coordinated. Each of the plurality of presentation panes is context sensitive. In certain embodiments, the workflow management routine facilitates one or more of data searching, data mining, and presentation of clinical evidence data at varying levels of granularity in conjunction with the plurality of presentation panes, for example.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A picture archiving and communication system comprising:
a workflow manager facilitating presentation and diagnostic interpretation of clinical evidence aggregated from a plurality of sources; and
a workflow screen including a plurality of presentation panes, each of said plurality of presentation panes displaying clinical evidence from the workflow manager according to a particular perspective, wherein said plurality of presentation panes are independent but coordinated and wherein each of said plurality of presentation panes is context sensitive.

2. The system of claim 1, wherein each of said plurality of presentation panes is configurable based at least in part on one or more of user preference, workflow, and display rules.

3. The system of claim 1, wherein each of said plurality of presentation panes is context sensitive based on at least one of clinical evidence in at least one of said plurality of presentation panes, workflow, workflow step, patient, and medical case.

4. The system of claim 1, wherein at least two of said plurality of presentation panes are synchronized in the display of clinical evidence.

5. The system of claim 4, wherein at least two of said plurality of presentation panes are synchronized such that an action in a first of said plurality of presentation panes impacts clinical evidence displayed in a second of said plurality of presentation panes.

6. The system of claim 1, further comprising a graphical user interface providing controls and overlay information for at least one of said plurality of presentation panes.

7. The system of claim 1, wherein said workflow manager allows a user to edit and save clinical evidence to one or more of said plurality of sources via said plurality of presentation panes.

8. The system of claim 1, wherein said plurality of presentation panes comprise one or more of a queue of examination cases, a history of medical events for a patient, a graphical representation of a human anatomy, a graphical representation of clinical evidence, and a clinical report.

9. The system of claim 1, wherein said workflow manager facilitates one or more of data searching, data mining, and presentation of clinical evidence data at varying levels of granularity in conjunction with the plurality of presentation panes of the workflow screen.

10. A method for presentation of clinical evidence, said method comprising:
aggregating clinical evidence from a plurality of information sources;
generating a workflow management screen from a plurality of presentation panes, each of said plurality of presentation panes displaying at least a portion of said clinical evidence according to a particular perspective, wherein said plurality of presentation panes are independent but coordinated and wherein each of said plurality of presentation panes is context sensitive; and
providing said clinical evidence for review via said plurality of presentation panes.

11. The method of claim 10, further comprising configuring each of said plurality of presentation panes based at least in part on one or more of user preference, workflow, and display rules.

12. The method of claim 10, wherein each of said plurality of presentation panes is context sensitive based on at least one of clinical evidence in at least one of said plurality of presentation panes, workflow, workflow step, patient, and medical case.

13. The method of claim 10, further comprising synchronizing at least two of said plurality of presentation panes in the display of clinical evidence.

14. The method of claim 13, wherein said synchronizing step further comprises synchronizing at least two of said plurality of presentation panes such that an action in a first of said plurality of presentation panes impacts clinical evidence displayed in a second of said plurality of presentation panes.

15. The method of claim 10, further comprising providing a graphical user interface including controls and overlay information for at least one of said plurality of presentation panes.

16. The method of claim 10, further comprising editing and saving clinical evidence to one or more of said plurality of information sources via said plurality of presentation panes.

17. The method of claim 10, wherein said plurality of presentation panes comprise one or more of a queue of examination cases, a history of medical events for a patient, a graphical representation of a human anatomy, a graphical representation of clinical evidence, and a clinical report.

18. The method of claim 10, further comprising facilitating one or more of data searching, data mining, and presentation of clinical evidence data at varying levels of granularity in conjunction with said plurality of presentation panes.

19. A computer readable medium having a set of instructions for execution on a computing device and a processor for executing the set of instructions on the computer readable medium, said set of instructions comprising:
a workflow management routine aggregating clinical evidence from a plurality of information sources; and
a workflow screen routine generating a plurality of presentation panes, each of said plurality of presentation panes displaying at least a portion of said clinical evidence according to a particular perspective, wherein said plurality of presentation panes are independent but coordinated and wherein each of said plurality of presentation panes is context sensitive.

20. The computer readable medium of claim 19, wherein said workflow management routine facilitates one or more of data searching, data mining, and presentation of clinical evidence data at varying levels of granularity in conjunction with said plurality of presentation panes.
